(19) United States
(12) Patent Application Publication
(10) Pub. No.: US 2010/0025380 A1
(43) Pub. Date: Feb. 4, 2010

(54) WELDING TORCH INCLUDING A CONVEX OPEN-WORK GRID FOR ENLARGING THE JET OF GAS

(75) Inventors: Bernard Bon, Ciel (FR); Alain Peigney, St. Loup De Varennes (FR)

Correspondence Address: CONNOLLY BOVE LODGE & HUTZ LLP, 1875 EYE STREET, N.W., SUITE 1100, WASHINGTON, DC, 20006, US

(73) Assignee: AREVA NP, Courbevoie (FR)

(21) Appl. No.: 11/917,462

(22) PCT Filed: Jun. 15, 2006
(86) PCT No.: PCT/FR2006/001363

§ 371 Date: Dec. 13, 2007

(30) Foreign Application Priority Data
Jun. 15, 2005 (FR) 0506082

(51) Int. Cl. B23K 9/16

(52) U.S. Cl. 219/74

(57) ABSTRACT

The invention relates to a welding torch comprising a torch body that is elongate along a longitudinal direction and that presents a working end, an electrode having a portion that projects longitudinally from the working end, and a channel for a flow of protective gas formed inside the body and terminating at the working end via at least one opening for ejecting gas in the form of a jet towards the projecting portion of the electrode. According to the invention, the torch includes jet-enlarger means for enlarging the jet of gas, which jet-enlarger means are in the form of a convex open-work grid covering the gas ejection opening(s).

The invention relates in general to a welding torch, in particular of the tungsten inert gas (TIG) or metal inert gas (MIG) type.

### BACKGROUND OF THE INVENTION

More precisely, the invention relates to a welding torch comprising a torch body that is elongate along a longitudinal direction and that presents a working end, an electrode having a portion that projects longitudinally from the working end, and a channel for a flow of protective gas formed inside the body and terminating at the working end via at least one opening for ejecting gas in the form of a jet towards the projecting portion of the electrode.

Torches of this type are used for butt welding thick plates together, the plates defining between them a groove that is narrow and deep. Such welding is performed in a plurality of passes. The initial passes which serve to fill the bottom of the groove are performed using a small diameter torch. The later passes that serve to fill the top portion of the groove are performed with a torch of larger diameter so that the jet of protective gas covers the entire width of the weld melt.

Making use of two different welding torches for the same welding operation is cumbersome and slows down operation. The dead time needed for mounting and demounting the torches and for adjusting the gas delivery means is considerable.

### OBJECTS AND SUMMARY OF THE INVENTION

In this context, the invention seeks to provide a welding torch with which it is possible to perform all of the passes when butt welding two thick plates together.

For this purpose, the invention provides a welding torch of the above-described type, including jet-enlarger means for enlarging the jet of gas.

The torch may also present one or more of the following characteristics taken individually or in any technically feasible combination:
the jet-enlarger means comprise a convex open-work grid covering the opening(s) of the channel, and bulging away from the opening(s);
the convex grid has a portion of hemispherical shape;
the convex grid is a trellis of metal wires defining between them spaces for passing the gas;
the torch includes an annular skirt surrounding the opening(s) and extending from the working end around the projecting portion of the electrode, the skirt presenting an open end opposite from its working end covered by the convex grid;
the convex grid is made of stainless steel;
the flow of gas through the convex grid is laminar;
it includes at least one jet-breaking grid that is substantially plane, being interposed in the flow of gas between the opening(s) and the convex grid;
the jet-enlarger means comprise a plurality of convex grids superposed on one another;
the torch body presents a section having a maximum dimension of less than 30 millimeters; and
the torch is adapted to the tungsten inert gas (TIG) and to the metal inert gas (MIG) welding methods.

### BRIEF DESCRIPTION OF THE DRAWINGS

Other characteristics and advantages of the invention appear from the description given below by way of non-limiting indication and made with reference to the accompanying figures, in which:

FIG. 1 is a longitudinal section view of a welding torch of the invention; and

FIG. 2 is an enlarged view of the working end of the FIG. 1 torch, with the jet of gas obtained with such a torch being represented by dashed lines, and the jet of gas obtained with a torch in the state of the art being represented by chain-dotted lines, by way of comparison.

### MORE DETAILED DESCRIPTION

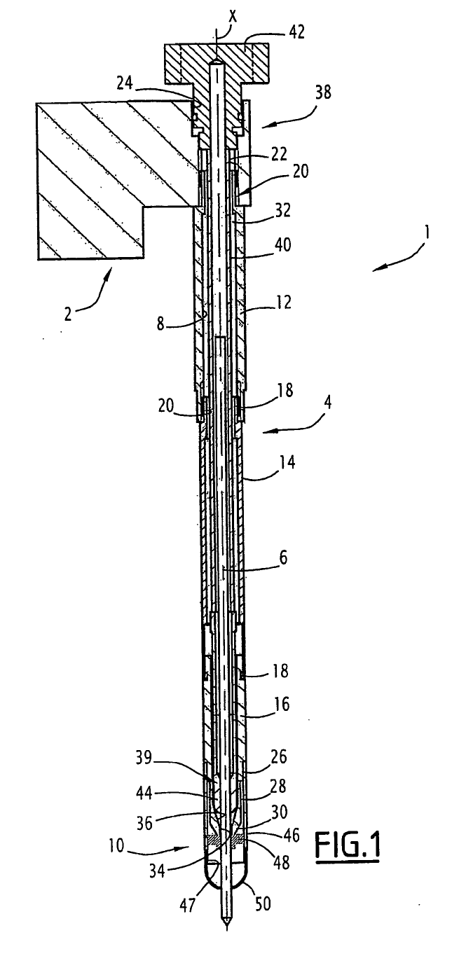

The welding torch 1 shown in FIG. 1 comprises a support block 2, a torch body 4 that is elongate in a longitudinal direction and that is rigidly fastened to the block 2, a longitudinal electrode 6 disposed inside the body 4, a flow channel 8 for a flow of protective gas formed inside the body 4, a backing electrode (not shown), and a voltage source suitable for maintaining a voltage difference between the electrode and the backing electrode.

The electrode 6 projects longitudinally from a working end 10 of the body 4 remote from the block 2.

The torch body 4 comprises three hollow cylindrical segments 12, 14, and 16 that are coaxial about a longitudinal axis X, and that are disposed in line with one another. The segments 12, 14, and 16 are screwed together via their respective ends. Gaskets 18 are interposed between them.

The block 2 is pierced by an orifice 20 having, towards the bottom in FIG. 1, a threaded portion 22 of relatively smaller diameter, and a non-threaded portion 24 of relatively larger diameter extending the threaded portion 22 upwards in FIG. 1.

The top segment 12 is screwed via a top threaded end in the threaded portion 22 of the orifice 20.

The working segment 16 is the furthest from the block 2, with the intermediate segment 14 interconnecting the segments 12 and 16.

Going from the segment 14, the segment 16 comprises a main portion of nominal outside diameter, a first shoulder 26 of diameter smaller than that of the main portion, then a second shoulder 28 of diameter smaller than that of the first shoulder 26, and finally a tapering end 30. It should be observed that the intermediate segment 14 is of nominal outside diameter and the fastener segment 12 presents an outside diameter that is greater than the nominal diameter. The nominal diameter typically lies in the range 8 millimeters (mm) to 30 mm.

The torch body 4 is made of refractory material.

The body 4 has an internal channel 32 extending along its entire longitudinal length and open at both ends, i.e. at the block 2 and at the working end 10.

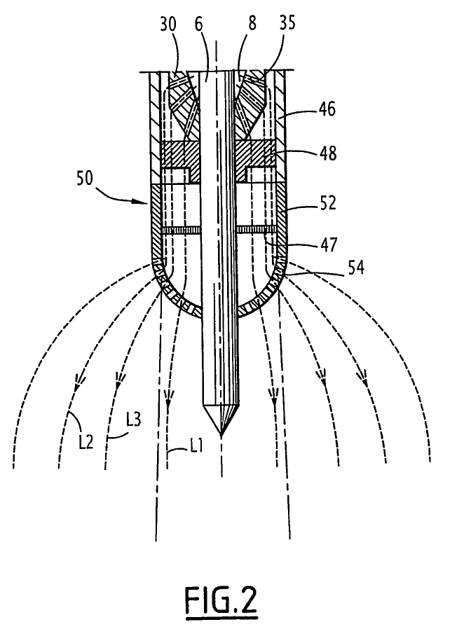

The internal channel 32 opens to the outside at the working end 10 via a round central opening 34 centered on the axis X and via a plurality of orifices 35 for ejecting the protective gas, which orifices are formed through the tapering end 30 (FIG. 2) disposed around the central opening 34.

The flow section of the internal channel 32 tapers progressively along the shoulder 28 and the tapering end 30, going towards the opening 34. The inside wall defining the channel 32 thus presents a portion 36 converging towards the opening 34 and extending along the shoulder 28 and the tapering end 30.

The electrode 6 is cylindrical in shape being longitudinally elongate and disposed in the internal channel 32 of the body 4 on the axis X. The electrode 6 extends along a portion of the segment 12, along the segments 14 and 16, and is engaged in the central opening 34. By way of example, the electrode 6 presents an outside diameter lying in the range 1.6 mm to 4 mm, and it projects from the working end 10 of the body 4 over about 50 mm.

The torch 1 also includes locking means 38 for locking the electrode 6 relative to the body 4. These means 38 comprise a tubular clamp 39 interposed between the electrode 6 and the working segment 16 of the body 4, a bearing tube 40 longitudinally adjacent to the clamp 39, and a screw 42. The clamp 39 presents a bottom end 44 subdivided into four equal sectors by longitudinal slots. This bottom end 44 bears longitudinally on the converging portion 36 of the inside wall of the channel 4.

The tube 40 bears via one end against the clamp 39. It extends along the segments 14 and 12 of the body 4 and is engaged in the portion 22 of the orifice 20.

The screw 42 is engaged in the non-threaded portion 24 of the orifice 20 and is screwed via a terminal portion in the threaded portion 22. It bears longitudinally against the tube 40. The screw 42 urges the tube 40 to move longitudinally towards the working end 10, the tube 40 in turn urging the clamp 38 towards the same working end 10. The segments of the split end 44 that bear against the converging portion 36 of the inside wall are thus urged radially towards the electrode 6 and clamp against it. The stress exerted by the split end 44 on the electrode 6 is a function of the longitudinal position of the screw 42 in the orifice 20.

The torch 1 also comprises a cylindrical skirt 46 for channeling the flow of gas, the skirt being of axis X and extending around the working end 10. The skirt 46 is rigidly fastened to the shoulder 26. It extends longitudinally from the shoulder 26 to a point that is substantially equidistant between the central opening 34 and the free end of the electrode 6. The skirt 46 surrounds the electrode 6 and the tapering end 30 of the tube 4. Its end 47 remote from the shoulder 26 is open.

The protective gas flow channel 8 corresponds to the annular space provided between firstly the segments 12, 14, and 16 of the torch body 4, and secondly the tube 40 and the clamp 38. The channel 8 is terminated at the working end 10 by gas ejection openings 35. These openings 35 put the channel 8 into communication with the space situated between the skirt 46 and the segment 16.

The torch 1 has means for feeding the channel 8 with protective gas, e.g. from cylinders (not shown) and via the block 2.

The torch 1 also has a plurality of plane jet-breaking grids 48 extending perpendicularly to the axis X. The jet-breaking grids 48 are stacked axially on one another, each presenting a circular shape of diameter corresponding to the inside diameter of the skirt 46. The grids 48 are rigidly fastened to the skirt 46 and they occupy the entire right section of the skirt 46. They have the electrode 6 passing through their centers. They are disposed against the tapering end 30 of the segments 16.

Each grid 48 is an open-work trellis of metal wires made using 304L stainless steel wires having a diameter of 0.16 mm. The wires are disposed in such a manner as to define empty spaces between one another that are square, having a side of about 0.5 mm.

The torch 1 also has a convex grid 50 rigidly fastened around the open end 47 of the skirt 46. The grid 50 is convex away from the gas ejection openings 35. It covers the entire open end 47 of the skirt 46.

The convex grid 50 has an annular portion 52 fastened to the outside of the skirt 46, extended by a hemispherical portion 54 covering the open end 47. As a result, the hemispherical portion 54 covers the ejection openings 35 in the sense that the gas ejected through said openings 35 necessarily blows through the portion 54. In other words, the portion 54 is interposed on the stream of gas flowing from the ejection openings 35 towards the projecting portion of the electrode. The electrode 6 passes through the portion 54 in its center.

Like the jet-breaking grids 48, the convex grid 50 is made in the form of an open-work trellis of metal wires. Here likewise, the wires are 304L stainless steel wires, e.g. having a diameter of 0.16 mm, and they are disposed in such a manner as to define between them empty spaces that are square with a side of 0.5 mm.

The radius of curvature of the hemispherical portion 54 of the grid 50 is about 5 mm, for example.

The length of the torch between the block 2 and the free end of the electrode 6 lies in the range 170 mm to 500 mm, for example.

The protective gas, is argon, or helium, or a mixture of argon and helium.

The protective gas flows from the block 2 to the working end 10 along the channel 8, is ejected from the body 4 in the form of a jet by the openings 35 into the inside space of the skirt 46 going towards the projecting portion of the electrode 6. The jet of gas as channeled by the skirt 46 then passes through the jet-breaking grids 48, by passing through the empty spaces. The jet of gas is then channeled by the skirt 46 to the convex grid 50, and passes through the portion 54 via the empty spaces thereof.

The gas leaving the body 4 flows in substantially laminar manner, longitudinally, to the grid 50. As shown in FIG. 2, the stream lines of fluid L1 situated in the center of the flow, i.e. along the electrode 6, pass through the convex grid 50 via spaces that are close to the electrode 6 and that are oriented substantially longitudinally or inclined a little relative to the axis X. These stream lines of fluid are practically undeviated on passing through the grid 50.

The stream lines of fluid L2 situated at the periphery of the flow, i.e. flowing along the skirt 46, pass through the grid 50 via spaces situated at the periphery of the grid. These spaces are oriented in directions that are steeply inclined relative to the axis X, such that the stream lines of fluid L2 that pass through these spaces are deflected strongly towards the outside of the flow on passing through the grid 50.

The fluid stream lines L2 situated in a zone that is intermediate between the electrode 6 and the skirt 46 pass through spaces of the grid 50 that extend in directions that are modestly inclined relative to the axis X, and are thus moderately deflected towards the outside of the flow.

The flow of gas is thus considerably broader downstream from the convex grid 50 that upstream from the same grid.

By way of comparison, in FIG. 2, the flow of gas that is obtained with a torch of the invention is represented by dashed lines, while the flow of gas that is obtained with a torch that is identical but that does not include the convex grid 50 is represented by chain-dotted lines.

In the absence of a convex grid 50, the flow of gas diverges very little from the open end 47 of the skirt 46. In contrast, when the torch has a convex grid 50, the flow of gas diverges quite clearly from the end 47 of the skirt 46. The right section of the flow of gas, taken perpendicularly to the axis X, is substantially twice as large with a convex grid 50 as without a grid 50, at the level of the free end of the electrode 6.

The above-described torch presents multiple advantages.

It has a convex grid made of metal wires that enable the flow of protective gas to be enlarged. This result is obtained at little expense.

The use of a torch of the above-described type, with a body that presents a small outside diameter, is particularly suited to performing butt welding of two parts that are separated by a deep and narrow groove, e.g. having a depth of 250 mm and a width of 20 mm. The torch can be used for the first welding passes in the bottom of the groove. During the initial passes, the weld melt is narrow, of width that is identical to the width of the groove. The same torch can also be used for the final passes, at a depth of less than 10 mm from the surfaces of the parts. During the final passes, the weld melt is much wider than in the bottom of the groove. Because the flow of protective gas from the torch is widened, it covers the entire weld melt, whether deep in the groove, or at the level of the outside surfaces of the parts being welded together.

The use of such a torch is particularly suitable during an operation of replacing a nuclear reactor steam generator. During such an operation, the pipework of the primary circuit is cut upstream and downstream from the steam generator that is to be replaced. The steam generator is then removed, leaving the remaining upstream and downstream segments waiting. Thereafter a new steam generator that is provided with upstream and downstream primary pipework stubs is put into place, and the pipework stubs are welded to the segments left waiting. The segments left waiting and the pipework stubs for butt welding thereto are parts of considerable thickness, each presenting a thickness of several tens of millimeters. At the time of welding, they are spaced apart by a gap having a width of about ten millimeters. When used under such circumstances, a torch of the above-described type is particularly advantageous because the same torch can be used for all of the welding passes. The operation is faster, since under such circumstances there is no need to use a first torch for performing the passes at the bottom of the groove and a second torch for performing the last passes close to the outside surfaces of the lengths of pipework. No dead time is required for changing the torch and making adjustments (gas flow rate, electricity feed) adapted to the operation of the second torch. Because these welding operations are performed in zones of the nuclear reactor where the dose rate is not negligible, shortening the time required to take action is of great importance, so as to minimize the exposure of the workers concerned to ionizing radiation.

The above-described torch is also particularly advantageous when welding in a ceiling, i.e. when the torch is situated under the parts being welded together. Under such circumstances, the convex grid 50 serves to protect the jet-breaking grid 48. Droplets of molten material falling from the weld melt are stopped by the convex grid 50 before reaching the jet-breaking grid 48.

The above-described torch may present numerous variants.

It is adapted for the TIG or MIG welding methods.

It can be used when welding with a filler metal or without a filler metal.

It can be used manually by an operator or in an automatic welding machine.

The body 4 may be cooled by circulating water, or it need not be cooled, depending on circumstances.

The convex grid 50 may present numerous forms. It may be hemispherical as described above. It may also be elliptical in section in a plane containing the axis X. It may even be irregular in shape, having a plane portion perpendicular to the axis X surrounding the electrode 6, and a rounded bulging portion extending between the plane portion and the open end 47 of the skirt 46.

The torch need not have a skirt 46. Under such circumstances, the convex grid 50 is fastened directly to the shoulder 28 or to the shoulder 26.

The torch may be employed for butt welding, whether end to end or side by side, or for corner welding.

It is adapted to welding together two parts of considerable thickness, but it can also be used for welding together two parts of small thickness.

It is adapted to welding with or without full penetration.

The description above relates to an embodiment in which the torch body has an outside diameter lying in the range 8 mm to 30 mm. Nevertheless, the torch body could equally well have a diameter greater than 30 mm.

The convex grid 50 could be replaced by other means for enlarging the flow of protective gas, e.g. an annular nozzle surrounding the electrode 6 and of a shape suitable for causing the flow of gas to diverge, or a frustoconical pierced plate disposed between the electrode 6 and the open end 47 of the skirt 46.

The torch may also include a plurality of convex grids 50 superposed axially one on another. Such grids 50 are normally of the same type (made using the same wires defining between them empty spaces of the same sizes), but they could equally well be of different types. They should be pressed against one another. The use of a plurality of superposed convex grids 50 makes it possible to obtain a gas jet in which the fluid streams are distributed in particularly uniform manner. The jet that is obtained is perfectly laminar.

What is claimed is:

1. A welding torch comprising a torch body that is elongate along a longitudinal direction and that presents a working end, an electrode having a portion that projects longitudinally from the working end, and a channel for a flow of protective gas formed inside the body and terminating at the working end via at least one opening for ejecting gas in the form of a jet towards the projecting portion of the electrode, the torch including jet-enlarger means for enlarging the gas jet, the jet-enlarger means comprising a convex open-work grid covering the opening(s) of the channel, the grid bulging away from the opening(s) and having the electrode passing therethrough.

2. A torch according to claim 1, wherein the convex grid has a portion of hemispherical shape.

3. A torch according to claim 1, wherein the convex grid is a trellis of metal wires defining between them spaces for passing the gas.

4. A torch according to claim 1, including an annular skirt surrounding the opening(s) and extending from the working end around the projecting portion of the electrode, the skirt presenting an open end opposite from its working end covered by the convex grid.

5. A torch according to claim 1, wherein the convex grid is made of stainless steel.

6. A torch according to claim 1, wherein the flow of gas through the convex grid is laminar.

7. A torch according to claim 1, including at least one jet-breaking grid that is substantially plane, being interposed in the flow of gas between the opening(s) and the convex grid.

8. A torch according to claim 1, wherein the jet-enlarger means comprise a plurality of convex grids superposed on one another.

9. A torch according to claim 1, wherein the torch body presents a section having a maximum dimension of less than 30 millimeters.

10. A torch according to claim 1, the torch being adapted to the tungsten inert gas and to the metal inert gas welding methods.

11. A torch according to claim 1, wherein the electrode passes through the center of the grid.
